(19) United States
(12) Patent Application Publication
(10) Pub. No.: US 2007/0017715 A1
(43) Pub. Date: Jan. 25, 2007

(54) Bogie slider control system and method utilizing trailer weight information

(76) Inventor: Gerard O. McCann, Kalamazoo, MI (US)

Correspondence Address: MARSHALL & MELHORN, FOUR SEAGATE, EIGHT FLOOR, TOLEDO, OH, 43604, US

(21) Appl. No.: 11/315,623

(22) Filed: Dec. 22, 2005

Related U.S. Application Data
(60) Provisional application No. 60/700,955, filed on Jul. 20, 2005.

(51) Int. Cl. B62D 61/10; B62D 53/06

(52) U.S. Cl. 180/24.02; 280/149.2; 180/290

(57) ABSTRACT

The present invention relates to a trailer bogie slider control system that utilizes trailer weight information from an electronic control brake system, anti-lock brake system, and/or anti-roll over electronic module. The trailer weight, which is obtained from suspension air bag pressure, is utilized by an operator to remotely engage and disengage the locking pins on a trailer bogie.

### FIELD OF THE INVENTION

The present invention relates to a trailer bogie slider control system and method that utilizes trailer weight information.

### BACKGROUND OF THE INVENTION

It is known that vehicles, such as trucks, tractors, or trailers in combination with tractors have at least one set of wheels with an associated suspension, which may utilize suspension air bags.

In the case of the trailer, the wheels and the suspension may be moved with respect to the trailer via a bogie. On the majority of new trailers in North America, the bogie (also known as a slider or bogie slider) is a component that slides along bogie rails to various positions (see FIGS. 1b, 2, and 3a-b). These positions are used, for example, to meet varying U.S. state-to-state regulations, to satisfy maximum king-pin to rear axle distances, and to adjust the weight balance between the rear axles of the tractor and the trailer axles. These positions may also allow for meeting various loading and unloading safety requirements.

Typically, adjustment of the bogie requires significant manual intervention by a vehicle operator, who walks to the rear of the trailer and uses a lever to engage/disengage the locking pins of the bogie to/from the trailer. Next, the operator returns to the cab and, with the trailer brakes applied, moves the trailer on the suspension until it is approximately correctly positioned.

Since it is unlikely for the operator to exactly position the locking pins on the first attempt, the operator repeats the sequence of moving the trailer as often as necessary to get the trailer to the desired position. Finally, when the correct position has been obtained, the operator reengages the locking pins to lock the trailer to the suspension.

Thus, it would be desirable to have a means by which the locking pins could be disengaged and reengaged directly from the tractor compartment. Further, it would be desirable if there was a display of bogie positions in the tractor compartment.

Additionally, after adjustment of the trailer suspension, it would be desirable for the operator to know how the weight distribution has been affected by the repositioning of the trailer suspension. Except for when the trailer is parked on a scale, the driver would benefit from having a weight distribution display in the tractor compartment. It is clear that it would be desirable for such a system to include a weight-readout for the operator so that the operator could see weight changes as they occur, when the operator moves the trailer on the suspension.

However, the above-stated enhancements must be carefully designed so as to prevent, for example, the locking pins from being erroneously disengaged from the corresponding holes on the slider rails, which could result in the trailer suspension being separated from the trailer with obvious adverse consequences. Basically, such enhancements must be designed to be fail-safe, so that the locking pins cannot disengage when the trailer is in motion and that the driver is presented with the correct state of the locking pins engagement/disengagement at all times.

Presently, electronic control brake systems (ECBS), for example, the trailer electronic brake system (TEBS) provided by Knorr-Bremse AG of Munich, Germany, are available that utilize one or more communication paths from the driver's foot to the ECBS control module. Typically, for a European application there would be at least one pneumatic path and at least one electronic path. These systems also provide the air pressure necessary for the brakes.

Advantages of such ECBS systems include a slightly faster brake application time and also the ability to optimize the actual brake application level to compensate, for example, for different loads on a particular axle or group of axles. Hence, some of the ECBS systems have a weight input. Frequently this weight input is provided by a pressure sensing arrangement which simply measures the pressure in the suspension airbags.

It should also be noted that ECBS systems almost invariably include Antilock Brake System (ABS) functionality. However, basic ABS systems normally do not have a direct weight measurement input, but would benefit from such an input. Frequently, basic ABS systems make a rough estimate of the weight balance between axles, or groups of axles, based on the relative degree of wheel speed decrease, which occurs during braking.

Another concern that may be considered in designing brake systems of a vehicle is the possibility-that the vehicle, especially a trailer, may roll over, where the position of the center of gravity may need to be considered. Other factors that may contribute to the vehicle rolling over are, for example, changing road conditions and/or weather conditions, adding, removing, or redistributing cargo, repositioning vehicle wheel assemblies, or repositioning the attachment of a vehicle cargo portion to the vehicle.

Currently, there are anti-roll over systems to deal with vehicle roll over and frequently these systems require some kind of weight input to optimize their function across changing load conditions. The severity of conditions which induce a rollover varies significantly with the height of the center of gravity. Usually anti-rollover systems do not have direct information about the height of the center of gravity. However, the anti-rollover systems may infer this height based on the weight of the vehicle.

Generally, as more weight is added to a trailer, the higher the center of gravity rises. In other words, as a load is added to the trailer, the mass is distributed between the floor and the roof. Thus, the overall center of gravity of the trailer rises. An exception to this might be, for example, plate steel which, because of its density, would not extend significantly from the floor upward before the allowed load limit for the trailer was reached.

Currently, anti-roll over systems frequently include automatic brake application functionality that lowers the vehicle speed, and may also cause the vehicle to slide slightly sideways rather than roll over. It is clear that such systems must be carefully designed to prevent inadvertent application of the brakes. Essentially, these systems must be fail-safe. The Knorr-Bremse ECBS system discussed earlier may include an optional anti-roll function that is designated as a roll stability program (RSP).

There are also available systems which measure weight for the sole purpose of presenting the weight information to the driver, or fleet. In this case, the pressure in the air suspension system is again monitored and simply displayed to the driver after suitable processing. Examples of such systems are provided by Airweigh Corporation of Eugene, Oreg.

Examples of other relevant art are as follows.

U.S. Pat. No. 5,025,877 to Assh teaches a vehicle load distribution system comprising a vehicle weight sensor connected to the front tires. The weight sensor can be a conventional pressure gauge or it may be a ruler device that measures linear lag or deflection of the suspension. The weight sensor may also include means for evaluating the effective load and calculating the distribution of the load over the axles.

U.S. Pat. No. 5,863,057 to Wessels provides a semi-tractor trailer load balancing system that utilizes a weight sensor that is mounted on the underside of the semi-trailer. The weight from the sensor is utilized by a computer to drive screws that cooperate with corresponding ball screws to physically slide the undercarriage of the semi-trailer into a balanced alignment.

U.S. Pat. No. 6,203,045 to Kyrtsos et al. generally discloses a plurality of sensors associated with the axles of a tractor and the axles of a trailer. In a preferred embodiment, the sensors are accelerometers that detect the amount of vertical acceleration of an axle. Kyrtsos et al. asserts that the amount of vertical acceleration is indicative of the amount of weight at each axle. A mechanical “axle mover” is utilized to physically move a first rear wheel axle of the trailer into a plurality of positions relative to a second rear wheel axle of the trailer.

U.S. Patent Application Publication No. 2003/0155164 to Mantini et al. describes a process for measuring the weight on every axle group on a truck and a trailer. The Mantini et al. publication indicates that the weight on each axle group can be measured using a series of pressure sensors associated with the air bags at each axle. As a result of these measurements, one or more microprocessors calculate the optimum position of the axle groups on the trailer.

A tractor-trailer combination would, however, benefit from a utilization of an anti-roll over electronic control system, electronic control brake system, and/or anti-lock brake system that determines the weight on a trailer axle by way of the air pressure in a trailer suspension air bag, which in turn provides that weight information to a tractor operator, who could then optimally position the trailer on the bogie without having to leave the tractor compartment.

### SUMMARY OF THE INVENTION

The present invention relates to a trailer slider control system which utilizes weight information from an anti-roll over electronic control module, electronic control brake system, and/or anti-lock brake system. The trailer weight information is obtained from air pressure in at least one trailer suspension air bag. The trailer weight information is then provided to a tractor operator, who in turn may remotely adjust a position of the entire trailer bogie in relationship to the trailer.

Further advantages of the present invention will be apparent from the following description and appended claims, reference being made to the accompanying drawings forming a part of a specification, wherein like reference characters designate corresponding parts of several views.

### BRIEF DESCRIPTION OF THE DRAWINGS

FIG. 1a is a three dimensional view of a vehicle and a trailer in accordance with the present invention;

FIG. 1b is a three dimensional view of a vehicle trailer bogie of the trailer of FIG. 1a;

FIG. 2 is a side view of two trailers whose vehicle trailer bogies are in different positions in accordance with the present invention;

FIG. 3a is a three dimensional view of a prior art manual locking pin system in accordance with the present invention;

FIG. 3b is a three dimensional view of an automatic locking pin system in accordance with the present invention;

FIG. 4a is a three dimensional front cut-away view of a pneumatic control module in accordance with the present invention;

FIG. 4b is a three dimensional rear cut-away view of the pneumatic control module of FIG. 4a;

FIG. 5 is a block diagram of an electronic control brake system and anti-roll over assembly in accordance with the present invention; and

FIG. 6 is a pneumatic schematic of the pneumatic control module of FIG. 4a.

### DETAILED DESCRIPTION OF THE PREFERRED EMBODIMENTS

It is to be understood that the present invention may assume various alternative orientations and step sequences, except where expressly specified to the contrary. It is also to be understood that the specific devices and processes illustrated in the attached drawings, and described in the following specification are simply exemplary embodiments of the inventive concepts defined in the appended claims. Hence, specific dimensions, directions or other physical characteristics relating to the embodiments disclosed are not to be considered as limiting, unless the claims expressly state otherwise.

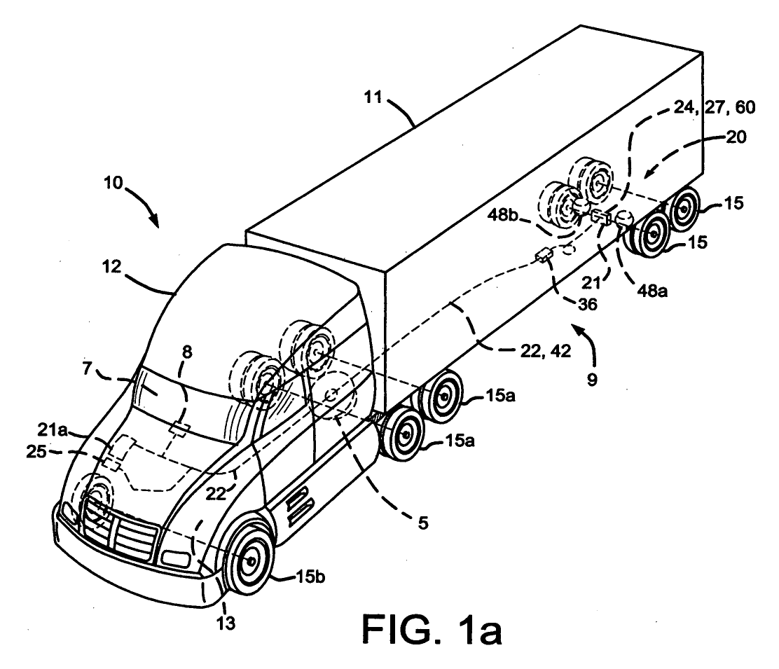

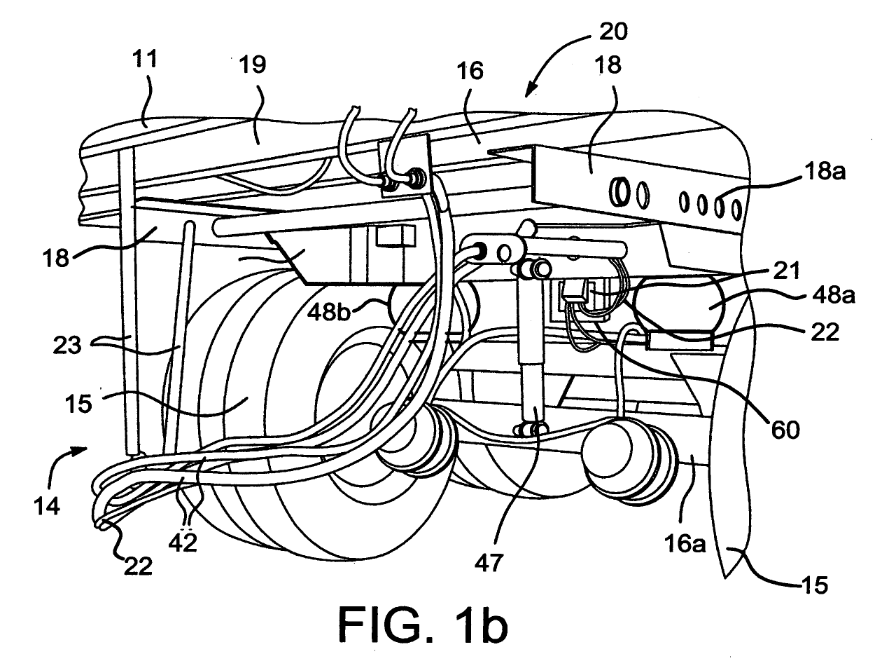

The present invention involves vehicles having a vehicle anti-roll over, ECBS, and/or ABS assembly 10, as FIG. 1a illustrates in an embodiment of a truck/tractor 12 having a cargo portion 11. The truck/tractor 12 has an engine 13, a cab compartment 7 with operator display 8, and wheels 15, 15a-b. If a fifth wheel/king-pin 5, which is common in the art, is utilized to pivotably attach the cargo portion 11 to the vehicle 12, then the cargo portion 11 is a trailer and the vehicle 12 is a tractor. Otherwise, the vehicle 12 may be a truck with an intimately attached cargo portion 11.

Also shown in FIG. 1a is a power and communication system 9 that comprises electrical cables 22, a pneumatic hose assembly 42, a remote distribution point 36, a pneumatic portion of an anti-roll over electronic control system, ECBS, and/or anti-lock brake system mechanism 60 (a.k.a., module), and a trailer module 21.

The trailer module 21 at least provides electrical control for one or more ABS, ECBS, pin engagement and disengagement, bogie position measurement, and/or anti-roll over functionality for the trailer 11. The trailer module 21 is attached to a trailer bogie slider 20. The trailer module 21 comprises an anti-roll over/ECBS/ABS control board 24 with an on-board controller 27 that may comprise a microprocessor.

FIG. 1b shows the bogie 20 in more detail having a frame member 16 that, in conjunction with the axle assembly 16a, helps to support at least one set of wheels 15 and an attached suspension 14, which has, for example, suspension member 47 and air bags 48a,b therebetween.

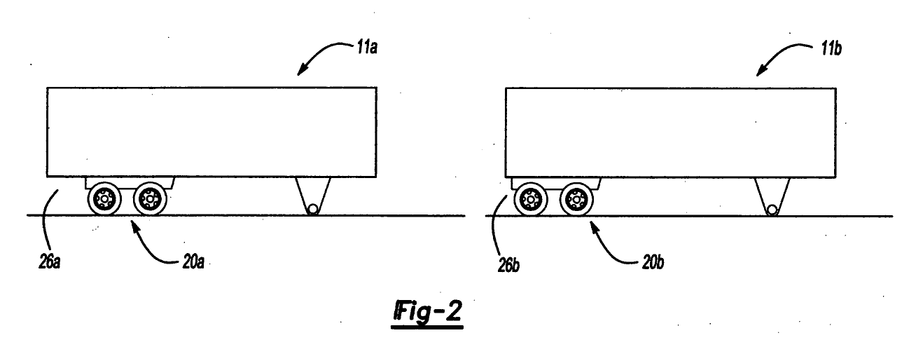

Typically, in the United States, the bogie 20 is positioned toward the rear of the trailer 11 (also see trailers 11a, 11b of FIG. 2) and is capable of forward and rearward slidable motion along rails 18, which have locking pin holes 18a. The rails 18 are disposed below a trailer floor 19.

The trailer module 21 typically draws power from the existing semi-tractor's power supply (not shown). The trailer module 21 electrically communicates with the tractor 12 and other devices on the trailer 11 by way of the electrical cables 22 and 22a-c.

The cables/air lines 22, 42 are suspended from springs 23, which are attached beneath the trailer floor 19. The electrical cables of the cables/air lines 22, 42 are connected to the anti-roll over/ECBS/ABS control board 24, which may be internal to the trailer module 21.

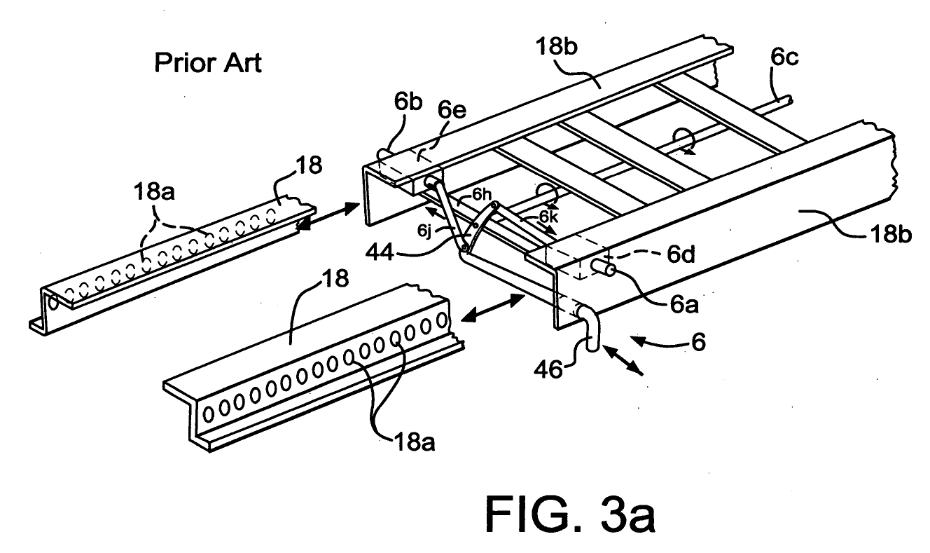

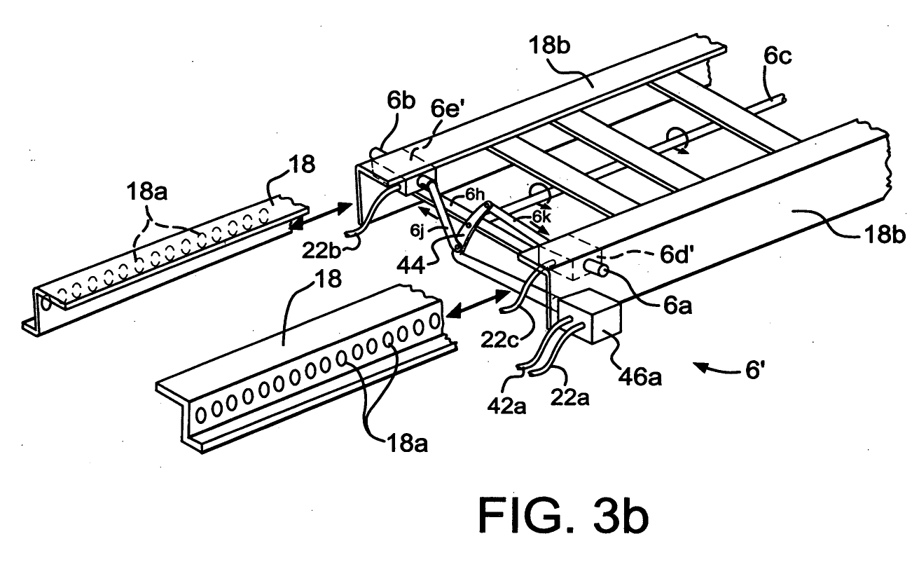

Slack is provided (as shown in FIGS. 1a-b) in the cables/air lines 22, 42 so as to allow for repositioning of the bogie 20. Repositioning of the bogie 20 is achieved by the rails 18 and a bogie frame portion 18b (see FIGS. 3a-b) cooperating with a locking pin mechanism 6 or 6′, which utilizes locking pins 6a,b and the locking pin holes 18a. For the sake of clarity, the rails 18 are shown in FIGS. 3a-b as being separated from the bogie frame portion 18b, but in operation the rails 18 and bogie frame portion 18b are in slidable contact.

An exemplary prior art mechanical locking pin mechanism 6 is illustrated in FIG. 3a, where the locking pins 6a,b are extended in a pin-engaged position. A handle 46 is utilized to engage/disengage the locking pins 6a,b. As shown, the locking pin mechanism 6 comprises the locking pins 6a,b, the handle 46, a handle arm 44, a cross member 6h, two pin arms 6j,k, two locking pin boxes 6d,e, and a shaft 6c.

When an operator pushes the handle 46 toward the bogie frame portion 18b, the handle arm 44 (whose movement rotates the shaft 6c) pivots clockwise. The handle arm 44 is supported by the cross member 6h. Also, the pin arms 6j,k are pushed, which causes their respective locking pins 6b,a to extend out of their respective locking pin boxes 6e,d, thus extending the locking pins 6b through locking pin holes 18a (i.e., engagement). In disengagement of the locking pins 6a,b, the handle 46 is forced away from the bogie frame portion 18b, thus reversing the above-stated motions that engage the locking pins 6a,b.

Although not shown, if it is required, the rotation of the shaft 6c can be communicated to another locking pin mechanism, thus engaging/disengaging another set of locking pins along the bogie frame portion 18b.

Alternatively, an automatic locking pin mechanism 6′, which is in accordance with the present invention, is illustrated in FIG. 3b. This mechanism 6′ could be employed for remotely controlling engagement/disengagement of the locking pins 6a,b. This arrangement would, for example, allow the operator to remain within the cab compartment 7 while moving the trailer 11 with respect to the bogie 20. In accordance with the present invention, FIG. 3b illustrates an automatic locking pin mechanism 6′ having a pneumatic/electrical actuator 46a that replaces the handle 46 of FIG. 3a. The actuator 46a is powered and controlled by the electrical cables 22a and/or pneumatic lines 42a.

The rest of the automatic locking pin mechanism 6′ may be conventional, as shown in FIGS. 3a,b, or completely automatic, and still remain within the spirit and scope of the present invention. In the locking pin mechanism 6′ of FIG. 3b, the pneumatic/electrical locking pin actuator 46a may be an automatic or manually operated pneumatic actuator controlled by a pneumatic valve or electrical solenoid valve that is common in the art. The actuator 46a might be operated by an electric motor in cooperation with mechanical gears, without the involvement of any pneumatics.

In the automatic embodiment of the locking pin mechanism 6′, the actuation may be provided by actuation signals from the controller 27 that is disposed on the control board 24, via the trailer module 21 (see FIGS. 1a-b and 5). The control board 24 and controller 27 might also employ electrical and logical control over anti-roll functions (e.g., RSP), electronic control brake system functions (ECBS), and anti-lock braking system functions (ABS) (see, for example, Knorr-Bremse Catalogue No. K001561-EN-001, which is incorporated herein by reference).

In accordance with the present invention, the locking pin boxes 6d′,e′, however, may also comprise locking pin position sensors (not shown but could be, for example, proximity switches, micro-switches, or limit sensors) that would be able to detect if the locking pins 6a,b are engaged or disengaged, and would be electrically connected to the controller 27 by way of the wiring 22c,b, respectively.

Thus, an operator would view the display 8 to see if the locking pins 6a,b and locking pin assemblies 6d′,e′ (with the pin position sensors) were engaged or disengaged. A processor, for example, the controller 21, a tractor ABS controller 21a, or the vehicle electronic control unit 25, would then interface the display 8 to the locking pin position sensors.

For mainstream North American applications, no dedicated communication wires are available between the trailer and the tractor. However, a power line carrier signal on the main 12 volt power line is currently used to support electronic communications. This would be available to provide the interface between the display and the locking pin position sensors. In addition, other communication methods are possible such as radio frequency communications or dedicated wiring for specialized applications.

Turning to FIG. 2, two vehicle trailers 11a, 11b, which are essentially the same, are illustrated having, respectively, bogies 20a, 20b. As can be seen, the bogie 20a is disposed toward the front (i.e., right) of the trailer 11a, leaving a gap in the rear area 26a of the trailer 11a. On the other hand, the bogie 20b is disposed toward the rear (i.e., left) of the trailer 11b, leaving no gap in the rear area 26b of the trailer 11b.

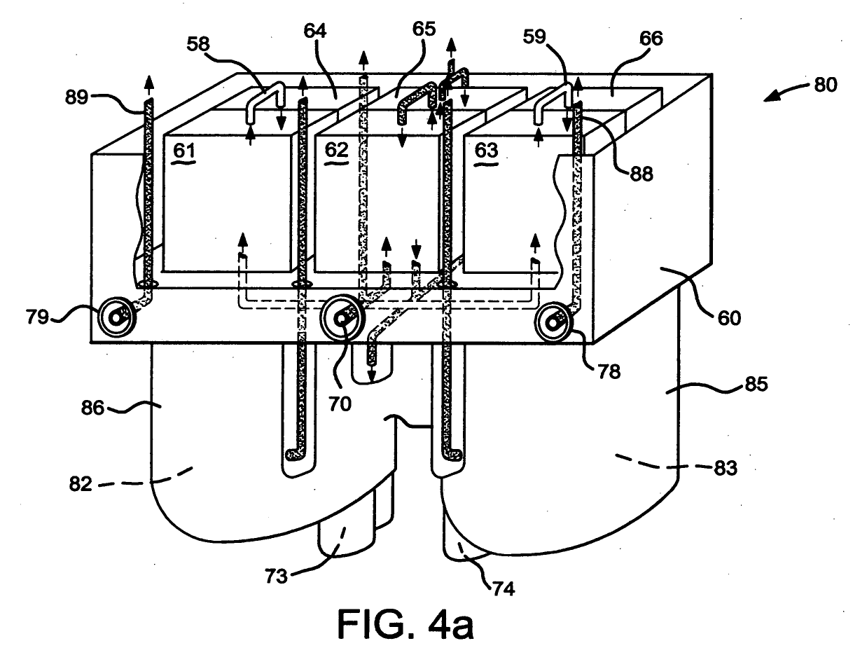

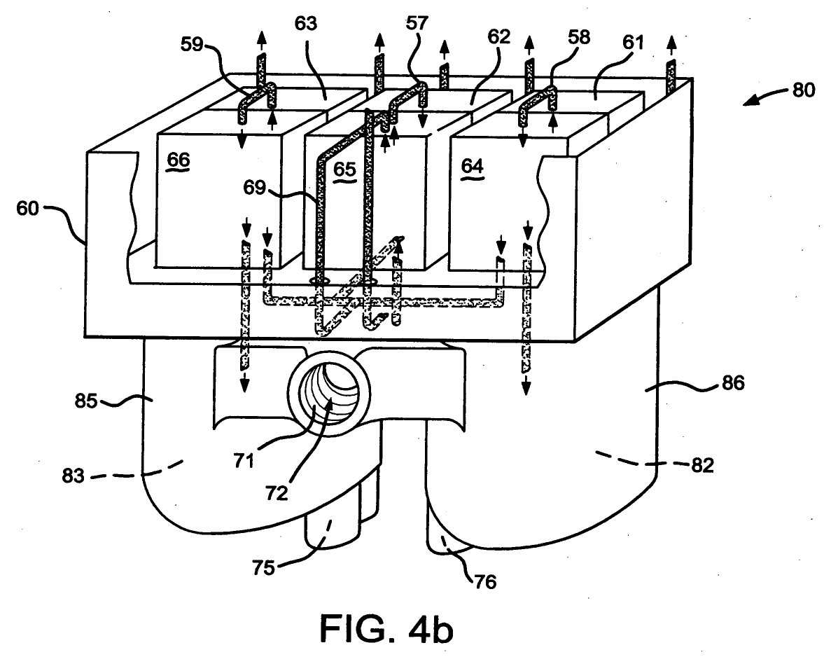

FIG. 4a illustrates a front cut-away view of a pneumatic portion of the anti-roll over electronic control system, electronic control brake system, and/or anti-lock brake system mechanism 60, which is most likely positioned near to or within the trailer module 21. Note that in FIGS. 4a,b arrows are utilized to illustrate various air flows. For some passages the arrows show the direction of air flow when the brakes are being applied. In other cases they show the respective direction of exhaust air flow during ABS activation or automatic anti-roll operation.

The arrows at connection ports 88 and 89 show the direction of air flow when their respective connector ports 78 and 79 are first pressurized. This mechanism 60 has two pairs of solenoids 61, 64 and 63, 66, which control air flow to the brakes (not shown) on each side of the trailer 11. The solenoids 63, 66 and 61, 64 essentially provide anti-lock brake control for the, respective, left hand side (LHS) of the trailer 11, and the right hand side (RHS) of the trailer 11.

In the present invention the right side is taken to mean the passenger side (a.k.a. the curb side) of a vehicle in the United States. The left side is taken to mean the driver side (a.k.a. the road side) of a vehicle in the United States.

Utilizing the two solenoids 63, 66 or 61, 64 to provide one ABS channel (in this case either the left side of the trailer or the right side of the trailer) of control is well known in the industry and is described in more detail in U.S. patent application 11/168,746 that was filed on Jun. 25, 2005, which is incorporated herein by reference.

In one possible arrangement, the solenoids 61, 63 are two way solenoids and the solenoids 64, 66 are three way solenoids. Item 58 is an air passage which connects between solenoids 61, 64, and item 59 is an air passage which connects between solenoids 63, 66. These solenoid pairs 61, 64 and 63, 66 also participate in anti-roll control as will be described below. The mechanism 60 also, includes relay valves 85, 86 and ports 73-76. Relay valves can be considered to . be pilot operated pneumatic regulators, since they isolate “control” air from “power” air and are well known and used practically universally in air brake systems.

Port 71 of the mechanism 60 is connected to a compressed air reservoir (not shown but conventional) on the vehicle/trailer 12, 11. For mainstream North American trailers, there typically are four output ports in all, each connected to one brake chamber on the trailer 11. For the mechanism 60, ports 74, 75 are typically connected to the two brake chambers on LHS of the trailer 11 and ports 73, 76 are typically connected to the two brake chambers on the RHS of the trailer 11. The arrow 72 shows the direction of airflow from the compressed air reservoir as brakes are being applied and air is flowing to the brake chambers.

Pneumatic connection 70 receives signal air, essentially representing the level of brake application that the driver is demanding. In summary, this air flows through double check module 62, then through solenoids 63 and 66 for the LHS of the vehicle, and through solenoids 61 and 64 for the RHS of the vehicle/trailer 11, 12.

Air from the upper portion of the mechanism 60 is ported down to chambers over the pistons 82, 83 in their respective relay valves 86, 85. In the event that pressure above the piston 82 in the relay valve 86 is greater than the pressure at the ports 73, 76, then air flows from the port 71 to the ports 73, 76, until the pressure at the ports 73, 76 is approximately equal to the pressure above the piston 82. Likewise, in the event that pressure at the ports 74, 75 is greater than the pressure above the piston 83, then air flows from the ports 74, 75 back to an exhaust port (not shown) at the bottom of the relay valve 85. This function is similar for the relay valve 86 and the ports 73, 76.

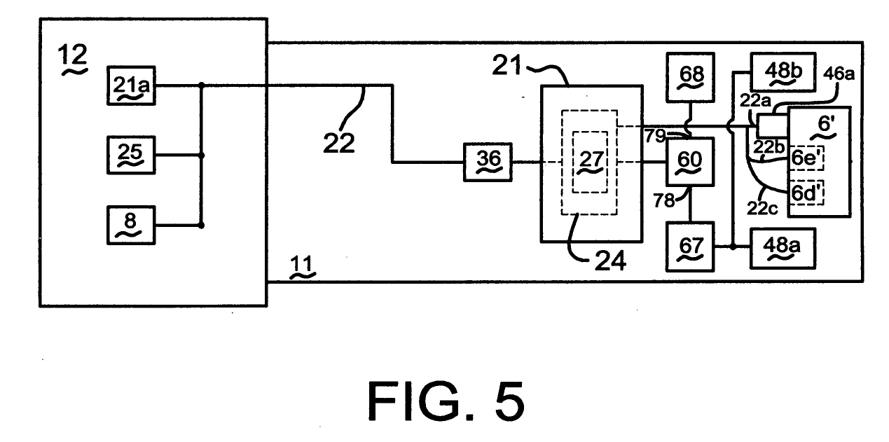

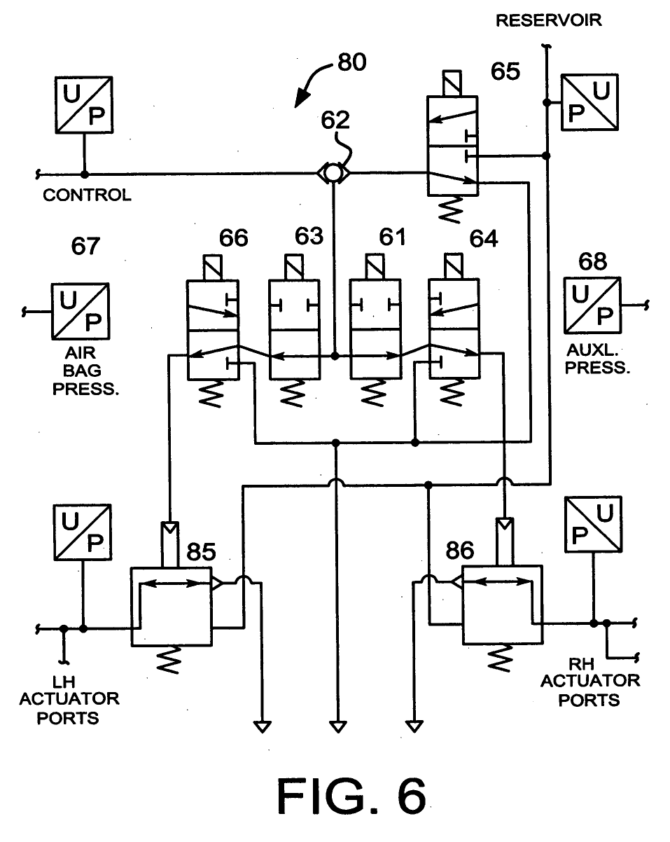

A printed circuit assembly (not shown) is disposed on top of the mechanism 60 and provides electrical activation for the solenoids 61, 63, 64, 65, 66. The mechanism 60 also incorporates pressure sensors that connect to the various ports shown (see arrows in FIGS. 4a-b and see FIG. 6). A single port 78, 79 is allotted, respectively, for each pressure sensor 67, 68 (see FIG. 5) for measurement of pressures (where U/P is defined as a pressure sensor) that originate external to the module 60. Usually the first pressure sensor 67 is allocated for measurement of the pressure in the suspension airbags 48a,b. The second pressure sensor 68 is then available for other purposes.

However, if desired, both sensors 67, 68 could be allocated for independent measurement of pressure for each side (i.e., respectively, left or right) of the trailer 11. The connector port 78 would connect through the port 88 to the pressure sensor 67. The connector port 79 would connect through the port 89 to the pressure sensor 68.

In either of the above stated arrangements (i.e., the mechanism 60 to sensor 67 or the mechanism 60 to sensors 67, 68) it is then clear that the mechanism 60 has weight information by way of the air bags 48a,b.

Thus, the present invention results in a single central anti-roll solenoid 65 that provides for an automatic brake application that is independent of the driver when impending roll conditions require it. The air from the anti-roll solenoid 65 passes through air passage 57 to double check valve module 62. The double check valve module 62 provides isolation between the application air from either the operator (via the port 70) or the anti-roll solenoid 65.

During an automatic brake application with the anti-roll solenoid 65, air passes through the LHS ABS solenoids 63, 66 and the RHS ABS solenoids 61, 64. The air then passes to the top of the pistons 82, 83 in the respective relay valves, 86, 85, thus causing braking.

Depending on the situation and the overall control strategy, the ABS solenoids 61, 64 and 63, 66 may participate in the resulting automatic brake application so that application air pressure is controlled to a level below a full braking application. If, however, air is allowed to flow directly from the anti-roll solenoid 65, then a full braking application would occur.

Normally, the weight on the trailer bogie 20 would be expected to enter into the determination of the optimum brake application level, since trailer weight information is provided by way of the connector 78, from the pressure sensor 67, via the airbags 48a,b. As noted previously pressure sensor 68 may also be utilized as part of the weight measurement system. Again reference is made to the Knorr-Bremse catalogue noted above.

FIG. 5 illustrates a block diagram of the various portions of the present invention. FIG. 6 depicts a pneumatic circuit 80 for the anti-roll over electronic control system, electronic control brake system, and/or anti-lock brake mechanism 60. Here, right hand side and left hand side designation is given for the various valves, solenoids, actuators, and air bags items of FIG. 4a, b. The numbered symbols correspond to the physical components shown in FIGS. 4a and 4b.

It should be noted that the pneumatic circuit 80 described here uses two independent channels (i.e., the RH solenoids 61, 64, and LH solenoids 63, 66, along with the corresponding RH/LH relay valves 86 and 85) for control of brake application pressure. However, it would also be possible to implement a pneumatic circuit similar to the pneumatic circuit 80 using just one channel of control (i.e., the solenoids 61, 64, and the relay valve 86) for the entire bogie 20. In the latter case, only three solenoids would be required. The solenoids 63, 66 and the corresponding relay valve 85 could be deleted.

It, therefore, is a discovery of the present invention that the suspension air bag weight information is communicated from the mechanism 60, to the controller 27, and then onto the operator via the display 8 in the tractor compartment 7. In addition, the operator is provided with the position of the locking pins 6a,b and, hence, remotely knows the status of the locking pins 6a,b (i.e., locking pins engaged or disengaged).

Thus, the operator remotely controls the engagement and disengagement of the locking pins 6a,b in the locking pin holes 18a, moves the tractor 12 accordingly, and controls the locking-in of the bogie 20 to the trailer 11 by engaging the locking pins 6a,b. This capability results in the operator adjusting the bogie 20 and, therefore, the weight distribution of the trailer 11, in a fail safe manner, without having to leave the tractor compartment 7. As a result, the present invention significantly utilizes the fail-safe capabilities that are built into the mechanism 60 and the circuit 80 to ensure the integrity of the bogie slider control system 10.

In accordance with the provisions of the patent statutes, the principles and modes of operation of this invention have been described and illustrated in its preferred embodiments. However, it must be understood that the invention may be practiced otherwise than specifically explained and illustrated without departing from its spirit or scope.

What is claimed is:

1. A trailer slider control system comprising:
a trailer, said trailer having a slider;
an anti-roll over electronic mechanism;
at least one trailer suspension air bag;
a pressure sensor in communication between said suspension air bag and said anti-roll over electronic mechanism for trailer weight information;
wherein, said trailer weight information is utilized for adjustment of a position of the entirety of said slider with respect to said trailer.

2. The control system of claim 1, wherein said trailer is attached to a tractor in a tractor-trailer combination.

3. The control system of claim 1, further comprising a display of said trailer weights and said slider position for an operator of said tractor.

4. The control system of claim 3, further comprising:
at least one locking pin, said locking pin utilized to lock a position of said slider in relationship to said trailer;
at least one position sensor, said position sensor utilized to determine if said locking pin is engaged or disengaged between said slider and said trailer; and
locking pin engagement and disengagement actuator for remote engagement and disengagement of said locking pin.

5. The control system of claim 4, further comprising a controller, said controller in power line carrier signal communication with said display for display of said remote engagement and disengagement of said locking pin.

6. The control system of claim 1, wherein said anti-roll over electronic mechanism includes an electronic control brake system and/or an antilock brake system.

7. A method of utilizing trailer weight information, comprising:
providing an electronic control having anti-roll functionality for a trailer having a trailer slider attached thereto;
providing at least one suspension system air bag, said air bag attached to said slider;
providing a pressure sensor communicating pressure in said air bag to said electronic control;
utilizing said anti-roll functionality to determine a weight of said trailer from said air bag pressure;
providing said trailer weight to an operator of a tractor, said trailer attached to said tractor; and
remotely adjusting a position of the entire trailer slider by said operator based on said trailer weight.

8. The method of claim 7, wherein said remotely adjusting said position of the entire trailer slider comprises engaging and disengaging locking pins on said trailer slider and sensing an engagement and a disengagement of said locking pins.

9. The method of claim 7, wherein said electronic control further comprises electronic control brake system functionality and/or an antilock brake system functionality.

10. The method of claim 7 further comprising displaying of said trailer weight.
